(19) United States
(12) Patent Application Publication
(10) Pub. No.: US 2025/0339713 A1
(43) Pub. Date: Nov. 6, 2025

(54) VALVE FOR A BREATHING REGULATOR

(71) Applicant: Dräger Safety AG & Co. KGaA, Lübeck (DE)

(72) Inventors: Carl-Christoffer Neumann, Lübeck (DE); Ing. Oliver Garbrecht, Lübeck (DE); Dominik Gaus, Lübeck (DE)

(21) Appl. No.: 19/196,465

(22) Filed: May 1, 2025

(30) Foreign Application Priority Data
May 6, 2024 (DE) 102024112658.2

(51) Int. Cl. A62B 9/02

(52) U.S. Cl. CPC A62B 9/02

(57) ABSTRACT

A valve for a breathing regulator, having a valve chamber in which there is arranged a spring-mounted piston which closes a downstream valve opening of the valve chamber when the valve is in a closed position is disclosed. A fluidic connection between the valve chamber and an external gas source can be established via an injection connector that has an injection opening. The valve furthermore has a valve outlet contour which is formed downstream in the region of the valve opening.

### CROSS-REFERENCE TO RELATED APPLICATIONS

This application claims the priority of German Patent Application No. 102024112658.2, filed on May 6, 2024, and titled “VALVE FOR A BREATHING REGULATOR,” which is hereby incorporated by reference in its entirety for all nonlimiting purposes.

### DESCRIPTION

The disclosure relates to a valve for a breathing regulator. The disclosure also relates to a breathing regulator and to a method for producing a valve for a breathing regulator.

Breathing regulators having valves that regulate a reliable supply of air to a breathing mask are known in principle; these include a breathing regulator for a compressed-air breathing apparatus commonly used by firefighters. Typically, such breathing regulators have a valve that ensures a permanent positive pressure in the breathing mask, for example in the firefighter's mask. As is known, a flow profile downstream the valve of the breathing regulator is predetermined by means of a corresponding outlet contour.

Given the high level of dependence of the wearer of the breathing mask on the functionality of the breathing regulator, such breathing regulators and thus also their valves undergo regular maintenance.

EP2514484B1 describes, by way of example, an embodiment of a known breathing regulator in which a flow profile is provided in the connection region between the breathing regulator and the breathing mask by means of a valve and a corresponding outlet contour.

The object of the present disclosure is to provide an improved valve for a breathing regulator, in particular a particularly reliable and easy-to-maintain valve for a breathing regulator.

According to a first aspect of the disclosure, to solve this problem, a valve for a breathing regulator is proposed, said valve having a valve chamber and a valve outlet contour.

In the valve chamber there is arranged a spring-mounted piston which closes a downstream valve opening of the valve chamber when the valve is in a closed position, wherein a fluidic connection between the valve chamber and an external gas source can be established via an injection connector that has an injection opening.

The valve outlet contour is formed downstream in the region of the valve opening and, by means of a partial tapering and a subsequent partial widening of a flow cross-section in the region of the valve opening, can generate a negative pressure in the region of the valve outlet contour by utilizing the Venturi effect, wherein the valve chamber and the valve outlet contour are formed together as a single piece.

In the context of the disclosure, it has been recognized that maintenance of a conventional breathing regulator is particularly time-consuming due to the valve of the breathing regulator being made up of numerous individual parts. Numerous individual parts also lead to a tolerance chain in the manufacturing process and thus to a lower quality of the component as compared to a single-piece valve. The single-piece design of the valve chamber and valve outlet contour particularly advantageously allows the valve to be easily removed from the breathing regulator for maintenance and/or cleaning purposes. In view of the use, according to the disclosure, of a single component, no readjustment of the valve, or only a readjustment of the spring-mounted piston, is necessary after the breathing regulator has been assembled. In addition, such a single-piece implementation of the valve chamber and valve outlet contour is particularly robust and reliable, so that damage during use with a breathing mask is unlikely. In addition, such a single-piece design has fewer gaps where dirt or the like can accumulate. Finally, the drying time after cleaning is also shorter owing to the smaller surface area.

The targeted generation of a negative pressure by utilizing the Venturi effect permits a targeted and more reliable interaction with other components of the breathing regulator, for example with a membrane which is located upstream of the valve and which controls the opening of the valve. Owing to the single-piece design of the valve chamber and valve outlet contour, and in particular owing to the use of the Venturi effect, such a flow profile and thus the provision of the negative pressure can be made particularly reliably reproducible. In particular, owing to the reproducible flow profile, pneumatic fluctuations when the flow interacts with other components of the breathing regulator are avoided.

The structure consisting of valve chamber and valve outlet contour and involving an exchange of gas via the valve opening can, together with the spring-mounted piston guided within the valve chamber, constitute a spring-damper system, such that in the context of the valve structure according to the disclosure, pneumatically induced vibrations of the piston can be dampened.

Finally, the single-piece design of the valve allows the breathing regulator to function even under extreme conditions, for example after an impact or shaking of the breathing regulator.

The use of fewer components for the breathing regulator than is the case with known breathing regulators also allows the valve and the breathing regulator equipped with this valve to be manufactured more easily.

Finally, by using fewer components for the breathing regulator, it is possible at least in part to dispense with sealing measures, such as O-rings, between the components.

The design of the valve chamber with an injection connector is known in principle to a person skilled in the art, and therefore different embodiments of the injection connector will not be discussed below.

The external gas source may be a compressed-air cylinder such as those used by firefighters and/or for in diving applications.

According to the disclosure, the partial tapering and the partial widening of the flow cross-section in the region of the valve opening lead to the Venturi effect owing to the similarity of parts of the valve outlet contour to a known Venturi nozzle. As is known, a Venturi nozzle also has a taper and a subsequent widening of the flow cross-section provided, thereby generating a particularly large flow in the edge region of the flow cross-section. According to the disclosure, a negative pressure is generated by virtue of the space upstream of the valve being evacuated by suction.

The partial tapering and the partial widening of the flow cross-section are to be understood in the context of this disclosure to mean that the flow generated downstream of the valve has properties at least partially comparable to a flow downstream of a Venturi nozzle. A tapering and a widening in partial regions of the flow cross-section is sufficient for this purpose, without the valve according to the disclosure having a classic Venturi nozzle. Alternatively or in addition, the valve according to the disclosure may have a classic Venturi nozzle.

Exemplary embodiments of the valve according to the disclosure will be described below.

In one example embodiment, the valve outlet contour is designed to use only a first proportion of the flow from the valve opening to generate a negative pressure by means of the partial tapering and the subsequent partial widening, and at the same time to use a second proportion of the flow to generate a homogenization of said flow by means of at least one deflecting structure of the valve outlet contour. Owing to the homogenization of the flow in the context of this embodiment, a particularly pleasant flow profile can be provided downstream of the valve to the user of a breathing mask arranged. In particular, the use of the Venturi effect may be combined with a uniform gas flow into the breathing mask connected to the valve. Owing to the partial tapering and the subsequent partial widening, it is possible in the context of the Venturi effect for a precisely defined air flow to be used for a fluidic connection to other components of the breathing regulator, without the high flow velocities of a classic Venturi nozzle being directed for this purpose to the wearer of the breathing mask.

In one advantageous variant of the preceding embodiment, the deflecting structure of the valve outlet contour is formed by an edge, a ring and/or a number of holes. Such deflecting structures can be provided particularly easily, for example in the course of a 3D printing process for the valve outlet contour. In addition, such deflecting structures permit a particularly efficient homogenization of the flow. The deflecting structure can be part of, and formed as a single piece with, the valve outlet contour. Alternatively or in addition, an external deflection element may be provided in the region of the valve outlet contour for the purpose of homogenizing the flow.

In a further embodiment, the valve outlet contour comprises a plurality of substantially rotationally symmetrically arranged Venturi nozzle segments. These Venturi nozzle segments bring about the partial tapering and partial widening, in accordance with the disclosure, of the flow cross-section downstream of the valve opening. The widening of the flow cross-section may be achieved by means of an abrupt end of the nozzle. The Venturi nozzle segments serve to deflect the flow outwardly, and in so doing divide the resulting flow into a proportion that generates a negative pressure in the context of the Venturi effect and another proportion that is guided directly and homogeneously via the deflecting structure into the mask for the wearer of the breathing apparatus. The rotationally symmetrical arrangement of these Venturi nozzle segments means that an influence of an orientation of the valve on the provided flow profile, in view of possible rotations of the valve during use, is reduced. Furthermore, this rotationally symmetrical arrangement permits a particularly reliable homogenization of the flow, as individual pressure peaks are avoided.

In a further embodiment of the valve according to the disclosure, the valve outlet contour is designed such that there is no complete rotational symmetry along a valve axis. In this embodiment, the valve outlet contour advantageously permits the orientation of the valve outlet contour to be individually adapted to the needs of a wearer of the corresponding breathing mask connected to the valve. In this exemplary embodiment, the valve outlet contour is formed with the deflecting structure, and the deflecting structure does not exhibit complete rotational symmetry. The avoidance of rotational symmetry, in particular the avoidance of rotational symmetry of the deflecting structure, can owing to non-linear effects lead to a particularly reliable homogenization of the flow. In the context of this embodiment, the valve axis is an axis extending in the direction of extent of the valve chamber, for example an axis extending along the piston.

In an example embodiment, a flow straightener, in particular a grille, is arranged on the valve outlet contour for the purpose of homogenizing at least proportion of the flow from the valve opening. In this context, it is conceivable for the flow straightener to be introduced directly into the valve and/or the valve outlet contour during the course of a 3D printing production process.

In an example variant, in addition to the flow straightener, the deflecting structure is arranged on the valve outlet contour. In the context of this embodiment, a flow straightener is any flat, partially permeable geometry that dampens and homogenizes turbulence, such as a grille. By using a flow straightener, in particular a wire grille, it can be reliably ensured that no excessively strong flows reach the wearer of the breathing mask. A grille width of the grille can be adapted to typical flow velocities downstream of the valve. The flow straightener may be a separate component which is arranged on the valve outlet contour via a connection, for example via an interlocking or frictional connection. As a separate component, the flow straightener can be cleaned particularly easily, and a grille structure, in particular a flow resistance of the grille structure, can be adapted to the individual needs of a user of the valve.

In an example embodiment, the valve chamber is substantially cylindrical, wherein the valve opening is formed in the region of a cylinder axis of the valve chamber. Such a cylindrical valve chamber permits a particularly simple mounting of the piston and a homogeneous pressure distribution within the valve chamber. Owing to the cylindrical shape, particularly heavy loading of individual regions of the valve chamber is avoided, thus making possible a long service life of the valve according to the disclosure. Finally, the cylindrical valve chamber makes it possible to achieve a small installation size of the valve according to the disclosure.

In one exemplary embodiment, a plurality of injection channels is formed in the region of the injection opening on the valve chamber for the purpose of uniformly injecting a gas to be provided into the valve chamber. The provision of a plurality of injection channels in the region of the injection connector is particularly advantageous. The gas to be supplied can be fed particularly uniformly into the valve chamber via the plurality of injection channels. The injection channels may for example be connected to an annular channel. Pneumatic compensation of a pressure loss at the annular channel can be made possible, for example, by means of variable diameters of these injection channels. A flow divider can also assist in achieving a uniform flow through the annular channel. The injection channels together with the annular channel may be part of the single-piece component consisting of the valve chamber and the valve outer contour.

In an example embodiment, the valve according to the disclosure is produced by means of a 3D printing process. This embodiment takes advantage of the fact that the 3D printing process is particularly suitable for producing complexly structured components. Since the valve according to the disclosure has a complex structure owing to the single-piece form of valve chamber and valve outlet contour, production by means of a 3D printing process ensures that the valve is produced particularly easily and cost-effectively. Finally, by using the 3D printing process, production of the valve can be automated particularly reliably. In addition, the use of the 3D printing process permits a variation of the precise geometrical structure of the valve outer contour, such as a height and/or an angle of incidence of a deflecting structure and/or of the Venturi nozzle segments.

According to a second aspect of the disclosure, to solve the aforementioned problem, a breathing regulator having a valve according to at least one of the preceding exemplary embodiments is proposed. Here, the spring-mounted piston is connected via a lever device to a membrane such that the valve is in a closed position or in an open position depending on a current position of the membrane.

The breathing regulator according to the second aspect of the disclosure has the valve according to the first aspect of the disclosure and thus has all the advantages of this valve. In particular, the breathing regulator according to the second aspect of the disclosure permits a particularly easy maintenance of the breathing regulator owing to the simple and robust design of the valve. Furthermore, the robust design of the valve makes it possible for the breathing regulator to function reliably even under extreme conditions, for example after an impact or shaking of the valve.

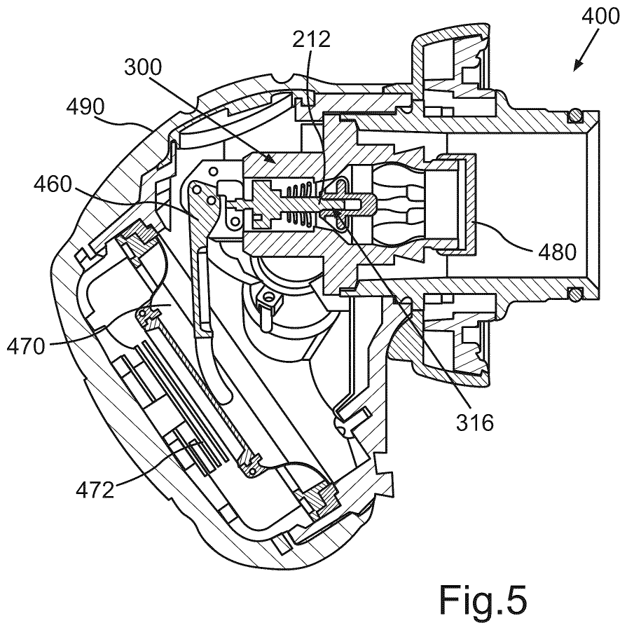

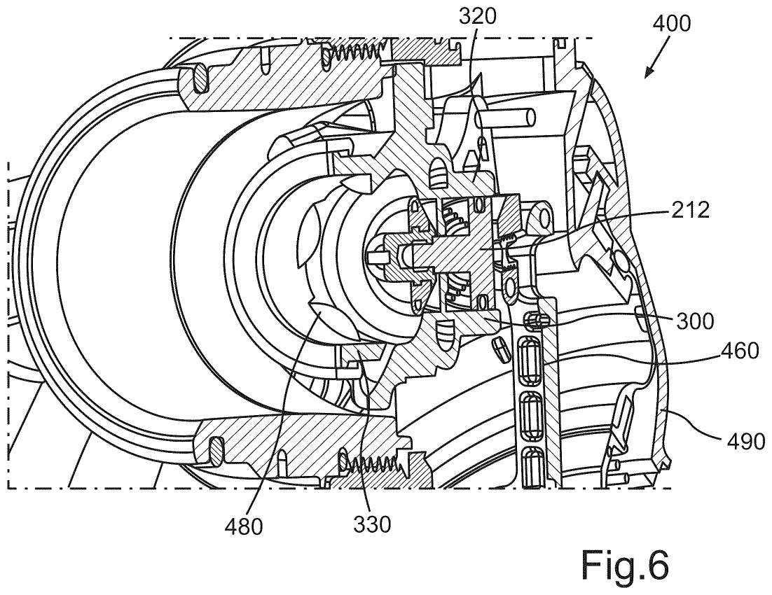

One possible arrangement of the piston and lever device relative to one another, and a connection of the lever device to the membrane, are shown in detail in the exemplary embodiments in FIG. 5 and FIG. 6. Such a lever device within a breathing regulator is furthermore known to a person skilled in the art.

In an example embodiment of the breathing regulator according to the second aspect of the disclosure, atmospheric pressure prevails at a first side of the membrane, and a negative pressure generated by means of the valve outlet contour can prevail at an opposite second side of the membrane via a corresponding fluidic connection. The negative pressure may also prevail as a result of the wearer of the breathing apparatus inhaling. In this embodiment, the negative pressure generated by means of the valve outlet contour is advantageously used for interaction with the membrane of the breathing regulator. As a result, the negative pressure prevailing owing to the Venturi effect allows a particularly precise control of the membrane, in particular a particularly stable dependency between the control of the membrane and the strength of the volume flow provided by the valve. This embodiment particularly advantageously utilizes the fact that the valve outlet contour generates a particularly stable local negative pressure. It can thus be ensured in this embodiment that, even in the case of high volume flows such as may arise during rapid breathing, the breathing gas is provided reliably because the membrane can, via the lever device, lead to a greater degree of opening of the valve and thus to a greater volume flow.

According to a third aspect of the disclosure, to solve the aforementioned problem, a method for producing a valve for a breathing regulator is proposed. The method comprises the steps:
providing a single-piece body which forms a valve chamber and a valve outlet contour of the valve;
arranging a spring-mounted piston in the valve chamber;
   wherein the piston closes a downstream valve opening of the valve chamber when the valve is in a closed position;
   wherein a fluidic connection between the valve chamber and an external gas source can be established via an injection connector that has an injection opening;
   and wherein the valve outlet contour which is formed downstream in the region of the valve opening is provided such that, by means of a partial tapering and a subsequent partial widening of a flow cross-section in the region of the valve opening, a negative pressure can be generated in the region of the valve outlet contour by utilizing the Venturi effect.

The method according to the third aspect of the disclosure is carried out by means of a valve according to the first aspect of the disclosure and therefore also includes the advantages of this valve. In particular, the provision of the single-piece body makes it possible to achieve a particularly robust structure of the produced valve.

The first step, that is to say the provision of the single-piece body, can take place before the spring-mounted piston is arranged in the valve chambers. The method according to the disclosure is can be carried out during the course of the production of a breathing regulator in which the valve is arranged. In this context, the method may be supplemented by further steps that may arise in connection with the installation of the valve into the rest of the breathing regulator, such as steps for fastening the valve within the breathing regulator.

In an example embodiment of the method according to the disclosure, said method further comprises arranging a flow straightener on the valve outlet contour for the purpose of homogenizing at least a proportion of the flow from the valve opening. This additional process step is may be carried out after the arrangement of the spring-mounted piston. The arrangement of the flow straightener may for example comprise an interlocking or frictional connection of the flow straightener to the valve outlet contour.

In an example embodiment of the method according to the disclosure, said method at least partially may comprise a 3D printing process. The single-piece body that forms the valve chamber and the valve outlet contour is can be provided by means of the 3D printing process. This permits the single-piece body to be provided with particularly precise reproducibility. In particular, the 3D printing process permits the method according to the disclosure to be automated particularly easily.

According to a fourth aspect of the disclosure, to solve the above-mentioned problem, a computer program having program code for carrying out a method according to the third aspect of the disclosure, in particular for carrying out a 3D printing process for producing a valve according to the first aspect of the disclosure, is proposed. The program code is executed on a computer, a processor or a programmable hardware component. A plurality of steps of the method according to the disclosure are carried out by a common computer, a common processor or a common programmable hardware component. The individual steps may be separated from one another, at least at the software level, by corresponding software blocks. All steps of the method according to the disclosure are carried out on or supported by a common computer, a common processor or a common programmable hardware component.

The disclosure will now be explained in more detail with reference to advantageous exemplary embodiments shown schematically in the figures, in which, in detail:

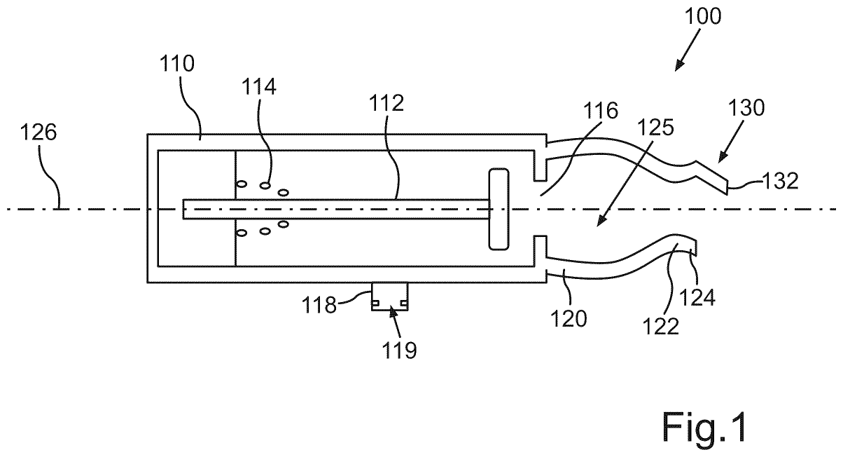

FIG. 1 is a schematic representation of a first example of a valve according to a first aspect of the disclosure;

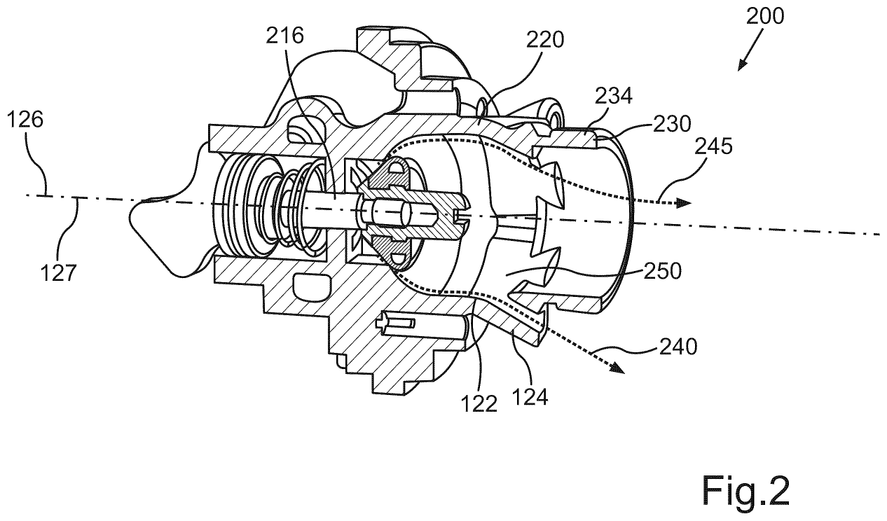

FIG. 2 is a schematic representation of a second example of the valve according to the first aspect of the disclosure;

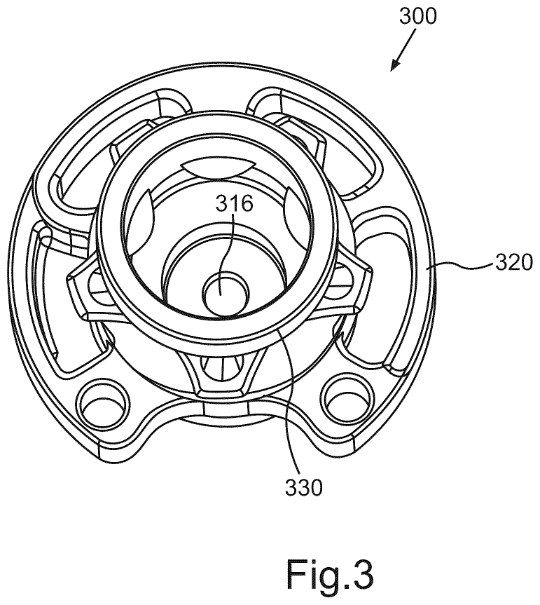

FIG. 3 is a front view of a third example of the valve according to the first aspect of the disclosure;

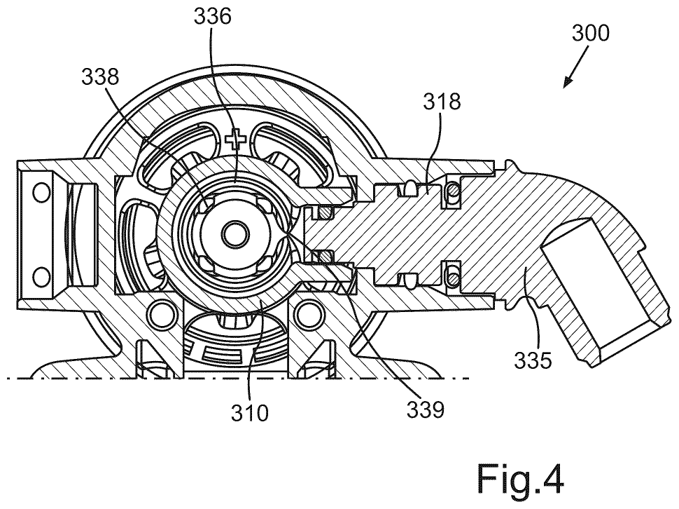

FIG. 4 is a sectional rear view of the third example of the valve having an injection connector according to the first aspect of the disclosure;

FIGS. 5, 6 are representations of an example of a breathing regulator according to a second aspect of the disclosure having the third example of the valve, wherein the breathing regulator is shown in a sectional plan view (FIG. 5) and in a sectional perspective view (FIG. 6);

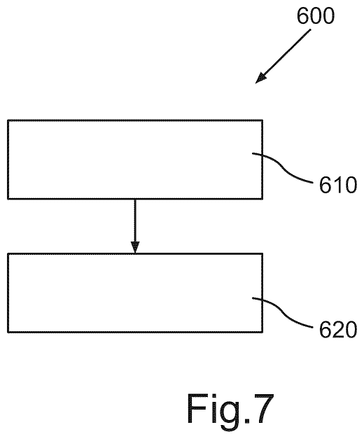

FIG. 7 is a flow chart of an example of a method according to a third aspect of the disclosure.

FIG. 1 is a schematic representation of a first exemplary embodiment of a valve 100 according to a first aspect of the disclosure.

The valve 100 is designed for a breathing regulator, as shown for example in FIG. 5. For this purpose, the valve 100 comprises a valve chamber 110 in which a spring-mounted piston 112 is arranged. The spring-mounted piston 112 is may be in contact with the valve chamber 110 via a spring 114. Depending on whether a force is applied to the spring-mounted piston 112, a downstream valve opening 116 of the valve chamber 110 is closed by the piston 112 when the valve 100 is in a closed position. The valve chamber 110 is in this case cylindrical, and on the corresponding lateral surface of the valve chamber 110 there is provided an injection connector 118 having an injection opening 119 that can be put into fluidic connection with an external gas source. The injection connector 118 has an interlocking injection connection (not shown) for securely connecting the injection connector to the external gas source. Such interlocking injection connections are known from commercially available breathing regulators and will therefore not be described in detail below.

According to the disclosure, a valve outlet contour 120 is formed downstream in the region of the valve opening 116. The valve chamber 110 and valve outlet contour 120 form a single-piece component of the valve 100. The valve outlet contour 120, due to its shape, specifically due to a partial tapering 122 and a subsequent partial widening 124 of a flow cross-section 125 in the region of the valve opening 116, makes use of the Venturi effect to reliably provide a negative pressure, in particular a negative pressure that is dependent on the air flow at the valve opening 116, in the region of the valve outlet contour 120. For example, the extent to which the valve opening 116 is opened by the piston 112 can be particularly reliably controlled by means of the negative pressure via a fluidic connection, as is described, for example, with reference to FIG. 5.

In the exemplary embodiment in FIG. 1, the partial tapering 122 and the subsequent partial widening 124 of the flow cross-section 125 can be seen in the illustrated longitudinal section on both sides of a cylinder axis 126 of the valve chamber 110. In other exemplary embodiments, a tapering with subsequent widening may be present in one region of the flow cross-section 125, whereas in the same flow cross-section for another flow path, there is a widening in parallel with said tapering. In this context, a partial tapering and a partial widening are present because they involve only proportions of a flow from the valve opening 116.

Finally, it can also be seen in FIG. 1 that the valve opening 116 is may be formed in the region of the cylinder axis 126 of the valve chamber 110. In exemplary embodiments that are not shown, the valve opening may also be arranged outside the cylinder axis.

In the exemplary embodiments presented in the descriptions of the figures, the valve outlet contour 120 additionally has at least one deflecting structure 130, which is intended to contribute to a homogenization of the flow downstream of the valve outlet contour 120. Pressure peaks within the flow cross-section felt by the user can thus be prevented, thereby improving comfort for said user. In the present case, the deflecting structure 130 is an edge 132. In principle, the deflecting structure 130 may be an edge, a ring, a number of holes or the like. In exemplary embodiments of the valve according to the disclosure that are not shown, the valve outlet contour may also be present without a deflecting structure. In further exemplary embodiments that are not shown, a deflection element is arranged as an external component in the region of the valve outlet contour in order to assist in homogenizing the flow.

The components of the valve as shown in FIG. 1 do not yet show details regarding the installation of the valve into an apparatus surrounding the valve, into a breathing regulator. For this purpose, the valve also may have specific installation characteristics such as connection holes, latching regions, a jacket contour of the valve chamber, or the like. An exemplary embodiment having such details is shown in FIG. 6.

Finally, FIG. 1 also does not show a mechanism for controlling the spring-mounted piston 112. This mechanism has been omitted from FIG. 1 for the sake of clarity. The piston may be controlled along the cylinder axis 126 by means of a lever device, such as that shown in detail in FIG. 5. Alternatively or in addition, the piston can also be moved in a direction outside the cylinder axis during an opening or closing process of the valve opening. Basically, it follows from the description of the disclosure that said disclosure can be implemented independently of details of the piston movement within the valve and can therefore be used for valves of different designs.

FIG. 2 is a schematic representation of a second exemplary embodiment of the valve 200 according to the first aspect of the disclosure.

The valve 200 differs from the valve 100 shown in FIG. 1 inter alia in that the valve outlet contour 220 is designed such that only a first proportion of the flow 240 from the valve opening 216 is used to generate a negative pressure by means of the partial tapering 122 and the subsequent partial widening 124. At the same time, a second proportion of the flow 245 is used to generate a homogenization of said flow by means of at least one deflecting structure 230 of the valve outlet contour 220. The deflecting structure 230 is in this case a ring 234 with an upstream ramp on which the flow can be dispersed for the purpose of homogenization. The two flows 240, 245 are shown in idealized form using arrows, wherein these flows may be formed proceeding from a plurality of different and mutually separate regions within a flow cross-section, depending on the design of the valve outlet contour 220. Physically, these two flows 240, 245 can be clearly distinguished on the basis of their pressure profiles because, without the Venturi effect, no particular acceleration occurs for the second part of the flow 245.

In the illustrated exemplary embodiment, the valve outlet contour 220 as that structural feature of the valve 200 which determines the flows 240, 245 comprises a plurality of Venturi nozzle segments 250 arranged substantially rotationally symmetrically about the cylinder axis 126. Parts of the deflecting structure 230 are also arranged offset from the Venturi nozzle segments 250. In this exemplary embodiment, the cylinder axis 126 forms a valve axis 127 of the valve. Such a Venturi nozzle segment gives rise, for a proportion of the flow in each case, to the partial tapering 122 according to the disclosure and the subsequent partial widening 124 of the part of the flow cross-section under consideration. The rotationally symmetrical arrangement permits a particularly efficient homogenization of the flow downstream of the valve outlet contour 220. In the present case, there are at least 3, in particular at least 4, particularly at least 5 Venturi nozzle segments.

The Venturi nozzle segments 250 may be designed to be slightly twisted in order to generate a flow component in the tangential direction in addition to a flow direction along the cylinder axis 126. This causes the Venturi effect to be sensitized to a counterpressure, such as that which arises at the end of an inspiration phase.

An angle of incidence of the valve outlet contour in the region of the Venturi nozzle segments 250 can be between 0° and 90°, in particular between 0° and 60°, relative to the cylinder axis 126.

FIG. 3 is a front view of a third exemplary embodiment of the valve 300 according to the first aspect of the disclosure. The front view is shown from a direction opposite to the flow direction, such that it is possible to directly see a piston passage into the valve chamber 310 and the valve opening 316, which appears here as a free cross-section, without the spring-mounted piston being shown.

The valve outlet contour 320 of the valve 300 as shown in FIG. 3 differs from the valve outlet contour 220 shown in FIG. 2 in that the valve outlet contour 320 does not exhibit complete rotational symmetry along a valve axis such as the cylinder axis (not shown here). The avoidance of rotational symmetry can assist in achieving fast homogenization of the flow velocities downstream of the valve outlet contour. In this case, rotational symmetry is avoided by means of a rotationally asymmetrical arrangement of elements of the deflecting structure 330.

In principle, the valve 300, like the valves 100, 200 in FIGS. 1 and 2, may be produced by means of a 3D printing process. Using such a 3D printing process, even complex structures can be produced reliably and reproducibly in large quantities. As a result, structures of the valve outlet contour 320 that are particularly suitable for homogenization and/or for the Venturi effect can be designed very specifically for a particular application, without this resulting in higher production costs for the production of the valve 300. For this reason, in particular the 3D printing of the single-piece component that forms the valve chamber and the valve outlet contour 320 can greatly simplify the production process of the valve 300.

FIG. 4 is a sectional rear view of the third exemplary embodiment of the valve 300 having an injection connector 318 according to the first aspect of the disclosure.

The rear view in FIG. 4 shows an exactly opposite perspective in relation to the front view in FIG. 3 such that, by contrast to FIG. 3, the valve chamber 310 and the valve outlet contour 320 cannot be seen. The view here shows the flow guidance from the external gas source 335 into a flow guide to the valve chamber. In the exemplary embodiment illustrated, this flow guidance takes place via an annular channel 336, which has a plurality of injection channels 338 for injecting the gas into the valve chamber 310.

The plurality of injection channels 338 makes it possible to achieve a uniform incoming flow to the valve seat. This assists in achieving a rotationally symmetrical outflow from the valve opening.

In the present case, the plurality of injection channels 338 comprises four injection channels 338. In principle, even at least two injection channels are advantageous. Each of the described exemplary embodiments may be provided with one or more injection channels.

A pressure loss through the annular channel 336 may be compensated for example by means of different diameters of the injection channels 338. The injection channels 338 may be round and/or have other cross-sections, such as a polygonal cross-section.

To make it possible to achieve a uniform incoming flow to the injection channels 338, a flow divider 339 is also provided directly downstream of the injection connector 318.

FIGS. 5 and 6 are representations of an exemplary embodiment of a breathing regulator 400 according to a second aspect of the disclosure having the third exemplary embodiment of the valve 300, wherein the breathing regulator 400 is shown in a sectional plan view (FIG. 5) and in a sectional perspective view (FIG. 6).

The breathing regulator 400 having the valve 300 comprises the spring-mounted piston 212 such that said piston is connected via a lever device 460 to a membrane 470. The valve 300 is thus in a closed position or in an open position depending on a current position of the membrane 470. The position of the membrane 470 in turn results directly from a relationship between the spring force of a membrane spring 472 connected to the membrane 470 and a negative pressure prevailing within the mask that is supplied with air by the breathing regulator 400. That side of the membrane 470 which is opposite the negative pressure is acted on both by the membrane spring 472 and by atmospheric pressure. A position of the membrane 470, and thus via the lever device also a position of the spring-mounted piston 212, can therefore be set through the targeted generation of a defined negative pressure by means of the Venturi effect downstream of the valve 300, and by means of a fluidic connection between the valve 300 and the membrane 470. A rapid and/or deep inhalation by the user of the breathing regulator 400 according to the disclosure can thus generate a high negative pressure which, via the piston position of the piston 212, leads to a greater flow through the valve opening 316 and thus to a higher negative pressure owing to the Venturi effect. This higher negative pressure can in turn influence the piston position such that the flow through the valve opening 316 is further increased. The valve outlet contour makes a high level of dynamics possible in the volume flows provided. The valve outlet contour 320 thus contributes, by means of the Venturi effect, to a reliable supply of breathing air even in the case of high consumption of breathing air, for example in a physically particularly demanding situation.

FIG. 5 and FIG. 6 also show that, in addition to the valve outlet contour 320 having the deflecting structure 330, a flow straightener 480, in particular a wire grille, arranged on the valve outlet contour 320 can also contribute to the homogenization of at least a proportion of the flow from the valve opening 316. In the present case, the flow straightener 480 is arranged on the valve outlet contour 320 by means of an interlocking connection using a retaining cap. This also makes it possible for the flow straightener 480 to be separately replaced and/or cleaned during maintenance. Alternatively, the flow straightener may also have a frictional or integrally bonded connection to the valve outlet contour. In the case of production using a 3D printing process, it is conceivable in principle for the flow straightener to be introduced directly into the valve and/or the valve outlet contour without the need to install additional parts such as a retaining cap.

In an alternative or additional exemplary embodiment that is not shown, the flow straightener is provided outside the valve, for example in a connection region between the breathing regulator and the mask, for the purpose of homogenizing the fluid flow provided.

The plurality of components shown in FIG. 5 and FIG. 6 also demonstrate, in principle, the effort involved in maintaining the breathing regulator. Small parts in particular may need to be cleaned manually and assembled correctly. Against this background, an advantage is also achieved from the provision of a single component for the valve chamber 310 and the valve outlet contour 320 in accordance with the disclosure. This avoids the need to clean small parts of the valve and reduces the assembly time required to assemble the valve 300.

FIG. 6 shows, by means of a perspective view, how the various components of the breathing regulator 400 are arranged in relation to one another and at least in part on a housing 490 of the breathing regulator 400 and are in fluidic contact with one another. The arrangement shown is merely by way of example. In particular, the valve 300 may be installed differently in different structures of breathing regulators, without the structure according to the disclosure of the valve and/or of the breathing regulator thereby being changed.

FIG. 7 shows a flow chart of an exemplary embodiment of a method 600 according to a third aspect of the disclosure.

The method 600 is designed for producing a valve for a breathing regulator. The method 600 comprises the method steps described below.

A first step 610 comprises providing a single-piece body which forms a valve chamber and a valve outlet contour of the valve.

A further step 620 comprises arranging a spring-mounted piston in the valve chamber, wherein the piston closes a downstream valve opening of the valve chamber when the valve is in a closed position, and wherein a fluidic connection between the valve chamber and an external gas source can be established via an injection connector that has an injection opening, and wherein the valve outlet contour which is formed downstream in the region of the valve opening is provided such that, by means of a partial tapering and a subsequent partial widening of a flow cross-section in the region of the valve opening, a negative pressure can be generated in the region of the valve outlet contour by utilizing the Venturi effect.

The two steps 610 and 620 are typically carried out in this sequence during the course of manufacture of the valve and/or manufacture of the breathing regulator equipped with the valve.

At least the step of producing the single-piece body that forms the valve chamber and the valve outlet contour of the valve can be implemented by means of a 3D printing process. In this case, suitable instructions in digital form can be provided to a 3D printer such that it prints the single-piece body according to the disclosure. Materials known for 3D printing, in particular known plastics, ceramics and/or metals, may be used as material. Such plastics, ceramics and/or metals typically exhibit a stability suitable for the valve according to the disclosure.

In a variant of the method according to the disclosure, said method further comprises arranging a flow straightener on the valve outlet contour for the purpose of homogenizing at least a proportion of the flow from the valve opening. This step may take place after the arrangement of the spring-mounted piston according to step 620. The arrangement of the flow straightener, in particular of a grille, is particularly a final step in the production of the valve. The arrangement may be carried out by means of a frictional, interlocking and/or integrally bonded connection. The flow straightener is particularly arranged on the valve outlet contour by means of an interlocking connection such as a screw connection and/or snap-action connection. Such an interlocking connection can particularly advantageously permit easy maintenance and thus a repeated execution of this method step.

### LIST OF REFERENCE SIGNS

100, 200, 300 Valve
110, 210, 310 Valve chamber
112, 212 Spring-mounted piston
114 Spring
116, 216, 316 Valve opening
118, 318 Injection connector
119 Injection opening
120, 220, 320 Valve outlet contour
122 Partial tapering
124 Partial widening
125 Flow cross-section
126 Cylinder axis
130, 230, 330 Deflecting structure
132 Edge
127 Valve axis
234 Ring
240 First proportion of the flow
245 Second proportion of the flow
250 Venturi nozzle segment
335 External gas source
336 Annular channel
338 Injection channel
339 Flow divider
400 Breathing regulator
460 Lever device
470 Membrane
472 Membrane spring
480 Flow straightener
490 Housing
600 Method
610, 620 Method steps

1.-10. (canceled)

11. A valve for a breathing regulator comprising:
a valve chamber in which there is arranged a spring-mounted piston which closes a downstream valve opening of the valve chamber when the valve is in a closed position,
wherein a fluidic connection between the valve chamber and an external gas source configured to be established via an injection connector that has an injection opening,
and having a valve outlet contour which is formed downstream in a region of the valve opening and which,
by means of a partial tapering and a subsequent partial widening of a flow cross-section in the region of the valve opening,
wherein the valve outlet contour is configured to generate a negative pressure by utilizing the Venturi effect,
wherein the valve chamber and the valve outlet contour are formed together as a single piece.

12. The valve according to claim 11,
wherein the valve outlet contour is designed to use only a first proportion of flow from the valve opening to generate a negative pressure by means of the partial tapering and subsequent partial widening, and at the same time to use a second proportion of the flow to generate a homogenization of said flow by means of at least one deflecting structure of the valve outlet contour,
wherein the deflecting structure of the valve outlet contour is formed by one or more of an edge, a ring or a number of holes.

13. The valve according to claim 11,
wherein the valve outlet contour comprises
a plurality of substantially rotationally symmetrically arranged Venturi nozzle segments;
or wherein the valve outlet contour is designed such that there is no full rotational symmetry along a valve axis.

14. The valve according to claim 11,
wherein a flow straightener is arranged on the valve outlet contour for homogenizing at least a proportion of the flow from the valve opening; or
wherein the valve chamber is substantially cylindrical and the valve opening is formed in a region of a cylinder axis of the valve chamber; or
wherein a plurality of injection channels is formed in a region of the injection opening on the valve chamber for the purpose of uniformly injecting a gas to be provided into the valve chamber.

15. A breathing regulator having a valve according to claim 11,
wherein the spring-mounted piston is connected via a lever device to a membrane such that the valve is in a closed position or in an open position depending on a current position of the membrane.

16. The breathing regulator according to claim 15,
wherein atmospheric pressure prevails at a first side of the membrane, and a negative pressure generated by means of the valve outlet contour can prevail at an opposite second side of the membrane via a corresponding fluidic connection.

17. A method for producing a valve for a breathing regulator, comprising:
providing a single-piece body which forms a valve chamber and a valve outlet contour of the valve;
arranging a spring-mounted piston in the valve chamber,
wherein the spring-mounted piston closes a downstream valve opening of the valve chamber when the valve is in a closed position,
and wherein a fluidic connection between the valve chamber and an external gas source is configured to be established via an injection connector that has an injection opening,
and wherein the valve outlet contour which is formed downstream in a region of the valve opening is provided such that, by means of a partial tapering and a subsequent partial widening of a flow cross-section in the region of the valve opening,
a negative pressure can be generated in a region of the valve outlet contour by utilizing the Venturi effect.

18. The method according to claim 17, further comprising arranging a flow straightener on the valve outlet contour for the purpose of homogenizing at least a proportion of the flow from the valve opening.

19. The valve according to claim 11,
wherein the valve (100) is produced by means of a 3D printing process.

20. The breathing regulator according to claim 15,
wherein the breathing regulator (400) is produced by means of a 3D printing process.

21. The method according to claim 17 further comprising a 3D printing process.

22. A computer program, embodied on a non-transitory computer-readable medium, having program code for carrying out the 3D printing process according to claim 19 when the program code is executed on a computer, a processor, or a programmable hardware component.

23. A computer program, embodied on a non-transitory computer-readable medium, having program code for carrying out the 3D printing process according to claim 20 when the program code is executed on a computer, a processor, or a programmable hardware component.

24. A computer program, embodied on a non-transitory computer-readable medium, having program code for carrying out the 3D printing process according to claim 21 when the program code is executed on a computer, a processor, or a programmable hardware component.
